(19) United States
(12) Patent Application Publication
(10) Pub. No.: US 2004/0249796 A1
(43) Pub. Date: Dec. 9, 2004

(54) Query classification

(75) Inventor: Saliha Azzam, Redmond, WA (US)

Correspondence Address: Brian D. Kaul, Westman, Champlin & Kelly, Suite 1600, 900 Second Avenue South, Minneapolis, MN, 55402-3319, US

(73) Assignee: Microsoft Corporation, Redmond, WA

(21) Appl. No.: 10/456,100

(22) Filed: Jun. 6, 2003

(51) Int. Cl. G06F 17/30

(52) U.S. Cl. 707/3

(57) ABSTRACT

In a method of classifying a query as pertaining to a type, a logical representation of an input query is received. Next, the logical representation of the input query is matched to a predefined query frame. The query frame identifies an entry point into a hierarchical typology of types and an object term. The typology is searched for the object term from the entry point. Finally, one or more types that are associated with the object term in the typology are output. Also provided is a query processing system that is configured to perform the above-identified method.

### BACKGROUND OF THE INVENTION

The present invention relates to input queries for query processing systems that receive and process input queries. More particularly, the present invention relates to methods of classifying the input query as pertaining to a particular type, which can be used by the query processing system to target the information sought by the user.

Query processing systems generally provide information to a user in response to an input query. These systems include search systems, question-answer (Q/A) systems, and other systems that process input queries. Search systems, in response to an input query, generally produce search results for the user in the form of documents and passages that are selected based upon a comparison of documents with key words of the input query.

Question-answer (Q/A) systems generally operate on queries that are intended to elicit a specific answer. It is often useful to classify such queries as relating to a particular type of answer that is being sought by the user. This allows such systems to narrow the search results to those that are likely to contain the answer sought after by the user. For a query of “Who is Benjamin Franklin's wife?”, it is the goal of the query processing system to search for relevant documents and passages that are likely to contain the name of Benjamin Franklin's wife, Deborah Read. A search of the keywords contained in the input query would merely result in documents and passages that contain the keywords of the input query without regard to whether they actually contain the type of answer that is desired, a person's name. However, by classifying the input query as pertaining to a specific type, the query processing system can narrow the search results to only those documents that relate to the identified type. As a result, the potential answer passages can be targeted to the particular answer sought by the user.

Most query classification systems utilize pre-defined query patterns or frames that are each associated with a particular type. A type for an input query is obtained by matching the input query to one of the query frames. The type can then be used to narrow search results that were retrieved in response to the input query to provide only those results that relate to the identified type. Unfortunately, such systems provide little flexibility in identifying more generic types when specific types fail to be applicable to the input query.

### SUMMARY OF THE INVENTION

The present invention provides input query classification in a manner that allows for more generic types to be provided in the event that more specific types fail to apply to the input query. One aspect of the present invention is directed to a method of classifying a query as pertaining to a type, in which a logical representation of an input query is received and is matched to a predefined query frame. The query frame identifies an entry point into a hierarchical typology of types and an object term from the logical representation of the input query. Next, the typology is searched from the entry point for the object term. Finally, one or more types that are associated with the object term in the typology are output.

Another aspect of the invention is directed to a query processing system that includes a parser, a query classifier, an engine, and a search result filter. The parser is configured to generate a logical representation of an input query. The query classifier includes a set of query frames and a hierarchical typology of types. The query classifier is configured to receive the logical representation of the input query and generate one or more types that relate to the input query. The engine is configured to provide search results corresponding to documents or passages that relate to the input query. The search result filter is configured to receive the search results and organize the search results in accordance with the types.

### BRIEF DESCRIPTION OF THE DRAWINGS

FIG. 1 is a block diagram of one exemplary environment in which the present invention can be implemented.

FIG. 2 is a block diagram of a Q/A system in accordance with embodiments of the invention.

FIG. 3 is a block diagram of a query classifier in accordance with embodiments of the invention.

FIG. 4 is a flowchart illustrating a method of classifying a query in accordance with embodiments of the invention.

FIG. 5 is an example of a hierarchical typology that is organized in accordance with a tree data structure.

### DETAILED DESCRIPTION OF ILLUSTRATIVE EMBODIMENTS

The present invention generally relates to classification of input queries for a query processing system, such as a search or question-answer (Q/A) system. More specifically, the present invention identifies types for the input query, which can be used in the query processing system to improve the precision of the answers that are retrieved by the system.

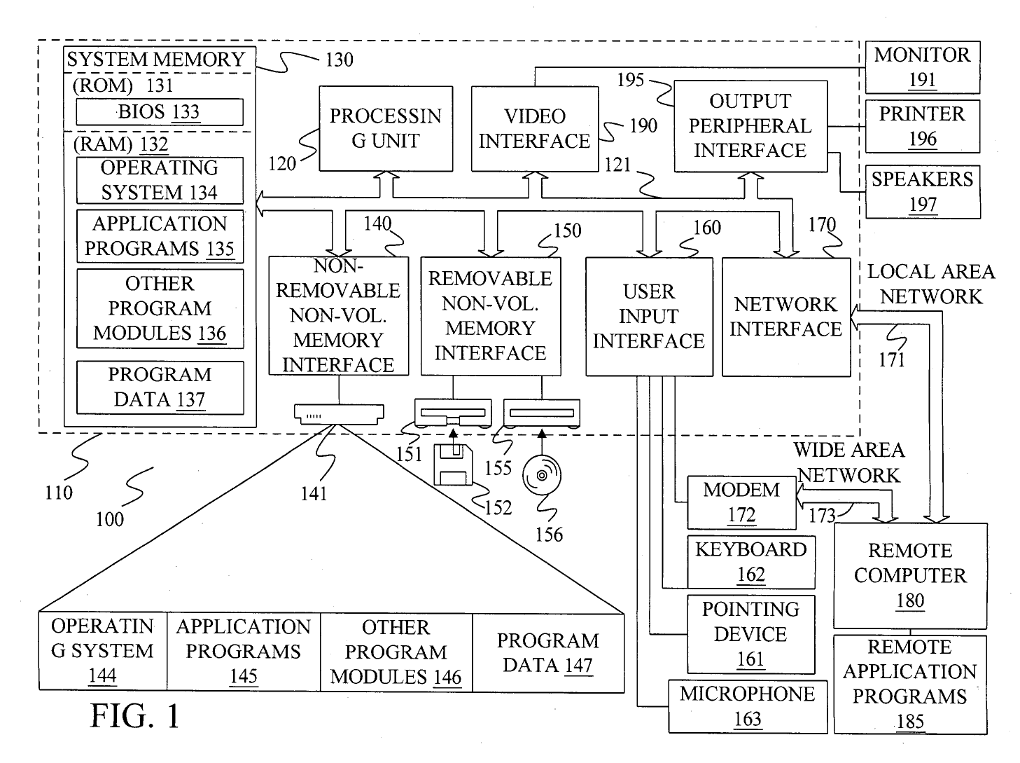

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way o example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

As noted above, the present invention can be carried out on a computer system such as that described with respect to FIG. 1. Alternatively, the present invention can be carried out on a server, a computer devoted to message handling, or on a distributed system in which different portions of the present invention are carried out on different parts of the distributed computing system.

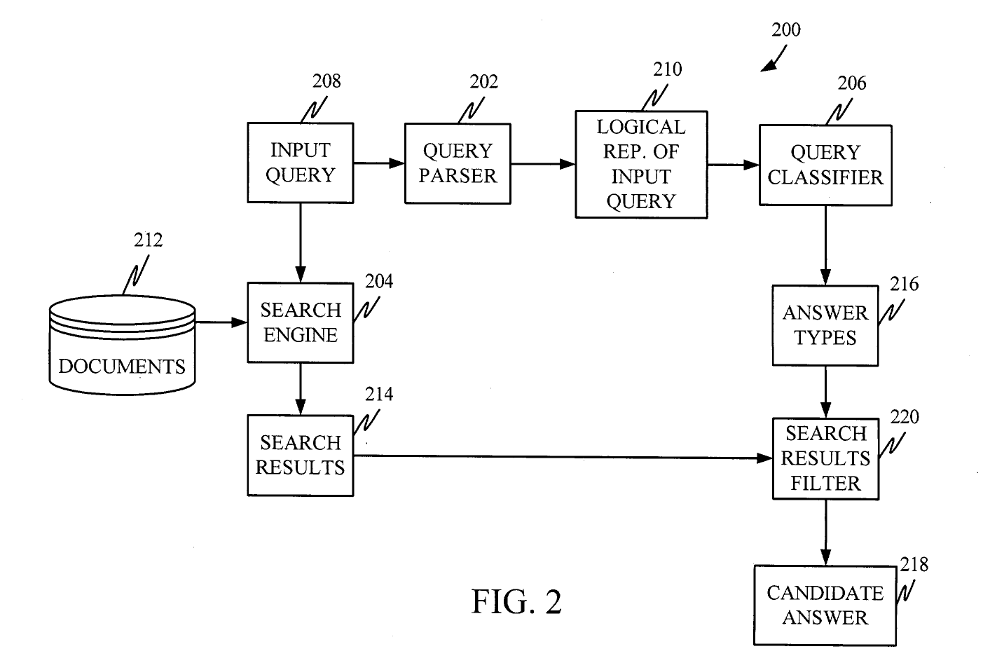

FIG. 2 is a block diagram of an example of a query processing system 200 in accordance with the present invention. System 200 is illustrated as a Q/A system that generally includes a query parser 202, a search engine 204, and a query classifier 206. An input query 208 submitted by a user is received by query parser 202. Query parser 202 performs parsing functions on the input query 208 in accordance with known methods to produce a logical representation of the input query 210. The query parser can be a general purpose parser rather than one built for queries only. Search engine 204 searches indexed documents 212 for documents that relate to the input query 208. The related documents and passages are retrieved as search results 214.

Query classifier 206 analyzes the logical representation of the input query 210 and identifies one or more types 216 that are associated with the input query. The types 216 generally identify a type of information that corresponds to the expected answer to the input query 208. For example, query classifier 206 would identify an input query of “When did World War II end?” as being associated with a type 216 of a “date”.

After search engine 204 performs the first selection of relevant documents to obtain search results 214, Q/A system 200 can use the identified type 216 to further process the search results 214 to extract candidate answers 218 that contain entities of the identified type, which are most likely to contain the answer to input query 208. This extraction of candidate answers 218 is performed by a search results filter 220, which identifies candidate answers 218 within the search results that are “tagged” with the same type 216. Accordingly, for the example provided above, search result filter 220 will extract passages that are identified or tagged with the type “date” and provide those answer passages 218 to the user typically after being ranked appropriately.

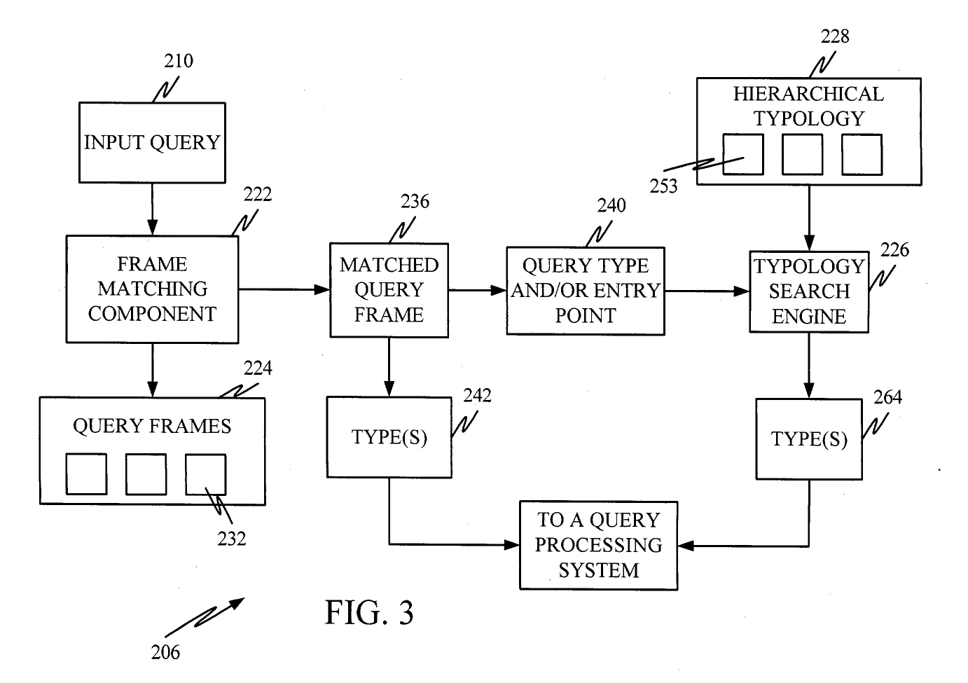

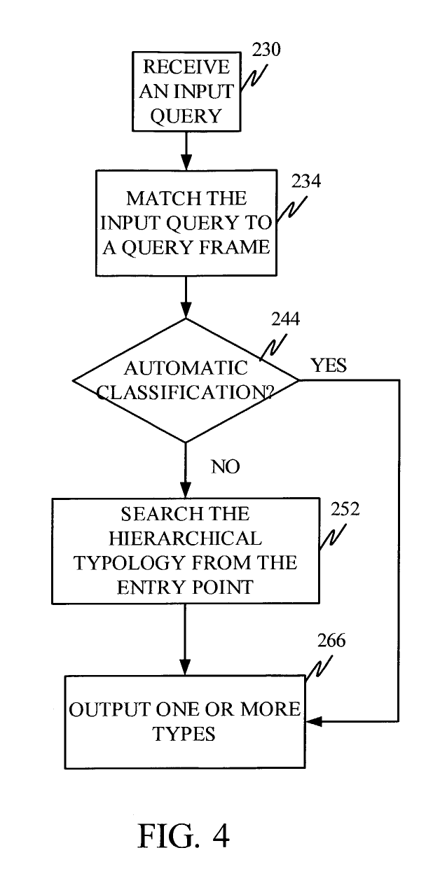

A more detailed discussion of query classifier 206 in accordance with embodiments of the invention will be provided with reference to FIGS. 3 and 4. FIG. 3 is a block diagram of a query classifier 206 in accordance with embodiments of the invention. FIG. 4 is a flowchart illustrating a method of classifying a query that can be performed by query classifier 206.

Query classifier 206 generally includes a query frame matching component 222, a query frame database 224, a typology search engine 226, and a hierarchical typology of types 228. Initially, at step 230 of the method, query frame matching component 222 receives a logical representation of the input query 210 from the parser 202 (FIG. 2).

The function of query frame matching component 222 is to associate the input query with a type. One challenge of such a job is the need to handle the various forms that queries having the same type can take. For example, input queries 208 of “The city of Rome is in what country?”, “Where is Rome?”, “Which country is Rome the capital of?”, “What country is Rome in?”, etc. are all associated to the same type of a “location” and, more particularly, a “country”. It is the function of query frame matching component 222 to identify these questions as pertaining to the same type of “location”. This is accomplished by matching a predefined query frame 232 from database 224 to the logical representation of the input query 210, as indicated at step 234.

Input queries 210 are matched to a query frame 232 when a set of constraint rules defined in the query frames apply on the logical form of the input query 210. For example, the input query of “Where is Rome?” will be matched to a query frame 232 corresponding to a normalized question of “Where is <X> . . . ?”. The matched query frame 236 is output by query matching component 222 broadly identifies a type 238, such as a “location” for the example above, and other information. The type 238 can be used as an entry point into hierarchical typology 228 that can be searched from the entry point to obtain more specific types for the input query 210, as will be described in greater detail below.

Query frames 232 that are defined by more constraint rules, will generally be associated with more specific types than those having fewer constraints. Accordingly, it is desirable to match the input query 210 to query frames 232 having the most constraints in order to identify the type for query 210 with greater specificity. In accordance with one embodiment of the invention, query frame database 224 is organized hierarchically based on shared constraint rules or logical form structures of the query frame 232. This organization of query frames 232 allows for easy identification of the query frame having the most specific patterns or constraint rules that matches the logical representation of the input query 210. Additionally, the hierarchical organization of query frame database 224 makes it easier to apply query frames having more generic constraints to the input query when the query frames having more specific constraint rules fail to match the input query.

Table 1 illustrates an example of an organization of the query frames of the database 224 that are covered by the patterns or constraint rules under a “HOW” frame node. The depicted frames under the “HOW” node are merely examples and others are possible. The “HOW” node can include “HOW-BE” and “HOW-DO” sub-nodes, for example. The “HOW-BE” node can further include a sub-node of “HOW-MODIFIER” corresponding to queries such as “How far is Seattle from Portland?”, and another sub-node of “HOW-MANY” corresponding to queries such as “How many miles are in a kilometer?”, for example, as shown in Table 1. Similarly, the “HOW-MUCH” node can include one or more sub-nodes such as a “HOW-MUCH-OF” node corresponding to queries such as “How much of the Earth is covered by water?”, for example. The “HOW-DO” node corresponds to verbs where the questions use the auxiliary “do”, such as “How do birds fly?”. The “HOW DO” node can also include sub-nodes of “HOW-MODIFIER” and “HOW-MUCH”. The “HOW-MODIFIER” can correspond to or identify queries such as “How long do turtles live?” whereas the “HOW-MUCH” node can correspond to queries such as “How much does an elephant weigh?”, for example. Accordingly, an input query that meets the constraint rules for the general “HOW” node can then be compared to the “HOW-BE” and the “HOW-DO” query frames or patterns to determine whether the input query corresponds to a more specific query frame contained in one of their sub-nodes. In this manner, more specific query frames 232, and thus, more specific answer types can be determined by traversing the hierarchically organized database 224 to find the query frame 232 that best matches the input query 210.

TABLE 1

HOW frames

HOW-BE frames

HOW-MODIFIER

How <modifier> <be> ...? −> How <far>
<is> Seattle from Portland? −> Answer
type of DISTANCE

HOW-MANY

How many <X> <be> ...? −> How many
<miles> <are> in a kilometer? −>
Answer type of DISTANCE

HOW-MUCH

How much <X> <be> ...? −> How much <is>
a computer? −> Answer type of
PRICE/MONEY
HOW-MUCH-OF

How much of <X> ...? −> How much of
the Earth is covered by water? −>
Answer type of
PERCENTAGE/FRACTION NUMBER

HOW-DO frames

HOW-MODIFIER

How <modifier> do Y <VERB>...? −> How
<long> do turtles <live>? −> Answer
type of DURATION/TIME

HOW-MUCH-

How much do X <VERB>...? −> How much
does an elephant <weigh>? −> Answer
type of WEIGHT MEASURE

As mentioned above, the matching of a query frame 236 to the input query 210 allows for the extraction of a type 240 that is associated with the input query 210. In some instances, the identified type 240 corresponds to an “open type” that is not predefined in the typology 228 or is otherwise the narrowest type that can be determined by the query classifier 206. As a result, the input query 210 can be automatically classified as having a type 242 corresponding to the type 240 identified by the matched query frame 236. Such automatic classification can generally be provided for input queries 208 corresponding to requests for information about a topic, such as input queries having a type of a “definition” as identified by the matched query frame 236. For example, an input query 208 of “What is an x-ray?” will have a type 240 of a “definition”, since it cannot be associated with a more specific type. Thus, if it is determined at step 244 of the method that the classification of the input query 210 is complete, the identified type 242 from the matched query frame 236 is preferably immediately output to a query processing system, such as search results filter 220 of Q/A system 200, as indicated by arrow 246 of FIG. 3.

In the event that the type 240 identified by the matched query frame 236 does not provide such automatic classification of the input query 210, the matched query frame 236 will identify an entry point into the typology 228 which is provided to typology search engine 226. In this case, the matched query frame 236 identifies an object term of the input query 210, which can be used to identify more specific or additional types within the hierarchical typology. Typology search engine 226 searches the types of the typology 228 from the entry point, as indicated at step 252 of the method, to identify more specific types for the input query 210.

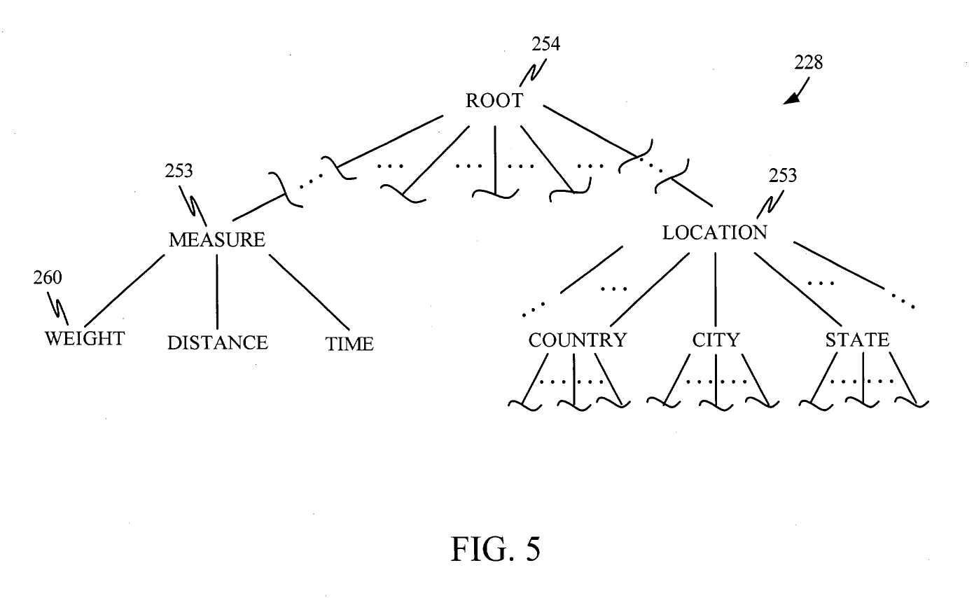

Typology 228 can contain many different types 253 that are organized in a hierarchical manner from generic to more specific. The hierarchical organization of the types of the typology allows more generic types to be identified as pertaining to the input query when more specific types fail to apply on the input query. Preferably, typology 228 is organized in accordance with a tree data structure having “root” 254 as the general type at the top of the tree followed by more specific types 253 extending therefrom, as illustrated in the example typology 228 of FIG. 5. Those skilled in the art understand that the typology 228 can be organized in accordance with other types of data structures.

The types 253 of typology 228 can relate to many different types of queries such as named entity types, lexical types, frame based structure types, and hybrid types, for example. Named entity types generally correspond to queries whose expected answers can be associated to, for example, proper names, like location names, person names, company names, etc. Lexical types are generally derived from lexical information such as Color, Food, etc. Frame based structure types relate to types that correspond more to relations between entities rather than to a single type to look for in a candidate answer passage, and require finding for all the types identified in the frame in the candidate answer passages. For example, an input query of “How did George Washington die?” can include types of “location” to answer where he died, “date” to answer when he died, and “reason” to answer why he died. Hybrid types are generally combinations of different category types. An input query of “How many countries are there in the world?” would have corresponding types of “number” and “country”, for example.

The type 240, identified by the matched query frame 236, identifies one of the types 253 of the typology 228 as an entry point into the typology 228. In this case, the matched query frame 236 also identifies an object term or secondary type of the input query 210 to identify more specific or additional types within the hierarchical typology 228.

The typology 228 is searched using the typology search engine 226 from the entry point for the object term identified by the matched query frame 236. For example, an input query of “How much does an elephant weigh?”, the matched query frame 236 will identify the entry point type 240 of the typology 228 as “measure” based upon the “How much” portion of the input query 210. Accordingly, typology search engine 226 begins the search at the “measure” node of the typology 228 shown in FIG. 5. The constraints of the query frame 236 would further identify “weigh” as an object term that relates to the type “measure”. The typology search engine 226 traverses the typology 228 from the entry point preferably in a top-down manner from the “measure” type 260 to locate the type 253 corresponding to the object term.

Once typology search engine 226 locates the appropriate types 253 within typology 228, it outputs one or more types 264 to a query processing system, such as search results filter 220 (FIG. 2) of Q/A system 200, as indicated at step 266 of FIG. 4.

Multiple types 264 can result from the matched query frame 236 identifying multiple types 253 of the typology 228 as relating to the input query 210, or when the located types 253 are associated with multiple types 264, i.e., frame-based. For example, the query “How big is Seattle?” can be associated with types 264 of “Area”, or “Population Number”.

Although the present invention has been described with reference to particular embodiments, workers skilled in the art will recognize that changes may be made in form and detail without departing from the spirit and scope of the invention. In general, query classification using the methods of the present invention can be used in query processing systems other than question answer systems. For example, the methods of the present invention can be useful in providing query classification for a set of related queries to generate a list of types that can be used to form a template for extracting corresponding answers from search results.

What is claimed is:

1. A method of classifying a query as pertaining to a type comprising steps of:
a) receiving a logical representation of an input query;
b) matching the logical representation of the input query to a predefined query frame, the query frame identifying an entry point into a hierarchical typology of types and an object term from the logical representation of the input query;
c) searching for the object term in the typology from the entry point; and
d) outputting one or more types that are associated with the object term in the typology.

2. The method of claim 1, wherein the searching step c) involves traversing the typology.

3. The method of claim 1, wherein the searching step c) involves traversing the typology in a top-down manner.

4. The method of claim 1, wherein the matching step b) includes comparing the logical representation of the input query to a set of query frames.

5. The method of claim 1, wherein the typology is organized in a hierarchical tree format.

6. The method of claim 5, wherein the entry point defined by the query frame is either a root of the tree or one of the types.

7. A method of associating a type to a query comprising steps of:
a) receiving a logical representation of an input query;
b) matching the logical representation of the input query to a predefined query frame, the query frame identifying an entry point into a hierarchical typology of types and an object term from the logical representation of the input query;
c) determining whether the matched query frame provides automatic classification of the input query;
d) searching for the object term in the typology from the entry point when the matched query frame does not provide automatic classification of the input query; and
e) outputting either a type defined by the automatic classification of the input query or one or more types that are associated with the object term in the typology.

8. The method of claim 7, wherein the searching step d) involves traversing the typology.

9. The method of claim 7, wherein the searching step d) involves traversing the typology in a top-down manner.

10. The method of claim 7, wherein the matching step b) includes comparing the logical representation of the input query to a set of query frames.

11. The method of claim 7, wherein the typology is organized in a hierarchical tree format.

12. The method of claim 11, wherein the entry point defined by the query frame is either a root of the tree or one of the types.

13. A query processing system comprising:
a parser configured to generate a logical representation of an input query;
a query classifier including a set of query frames and a hierarchical typology of types, the query classifier configured to receive the logical representation of the input query and generate one or more types that relate to the input query;
an engine configured to provide search results corresponding to documents or passages relating to the input query; and
a search result filter configured to receive the search results and organize the search results in accordance with the types.

14. The system of claim 13, wherein the query classifier is further configured to match the logical representation of the input query to one of the query frames, identify an entry point in the typology and an object term of the input query, search the typology for the object term from the entry point, and output the types that are associated with the object term in the typology.

15. The system of claim 13, wherein the typology is organized in a hierarchical tree format.

16. The system of claim 14, wherein the entry point is either a root of the typology or one of the types.
